(19) United States
(12) Patent Application Publication
(10) Pub. No.: US 2015/0020677 A1
(43) Pub. Date: Jan. 22, 2015

(54) Collapsible Transportable Live Electric Music Station For The Solo Performer

(71) Applicant: Eugene Joseph Perry, Saint Ignace, MI (US)

(72) Inventor: Eugene Joseph Perry, Saint Ignace, MI (US)

(21) Appl. No.: 14/251,630

(22) Filed: Apr. 13, 2014

Related U.S. Application Data
(60) Provisional application No. 61/814,245, filed on Apr. 20, 2013.

(51) Int. Cl. G10H 1/00

(52) U.S. Cl. CPC G10H 1/0008; G10H 2210/155
USPC 84/746

(57) ABSTRACT

An all-in-one collapsible, transportable live music station for the travelling solo musician performer, containing various needed devices on a central two-wheeled hand truck. The device contains an audio effects pedalboard with foot-controlled music accompaniment effects, a personal self-amplified monitor, a microphone on a boom, and a music stand for holding paper song sheets or computer device serving the equivalent. The device can also contain a side cup holder, a side sheet music trough, an act name banner shingle and a miscellaneous cargo basket. In its stowed state, it is narrow enough to be tipped and wheeled through most standard doorways, and light enough to be lifted by a single person into a vehicle. It can be deployed out for a seated solo musician (most likely a singing guitar player) to comfortably utilize all its features during performances. The device saves much time and effort with gear transport, set-up and breakdown.

### CROSS-REFERENCE TO RELATED APPLICATIONS

Provisional Application Number 61814245 of Apr. 20, 2013.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not Applicable.

### BACKGROUND OF INVENTION

The present invention is in the technical field of music performance. It mostly addresses a need of a travelling seated professional solo acoustic guitar player and singer, but could be applied more broadly to a solo performer of any hand-held instrument, generally, especially those that utilize foot-controlled audio backing tracks and effects during performances.

Musical technology options for the solo entertainer are increasing, but the utilization of much of this newly offered technology presents an increasing complexity in the regular set-up and breakdown required for performances each time. While it is fairly manageable for a performer to just set up a simple microphone, mic stand, music stand and PA system, the more pieces that are added on to a “rig” beyond this, the more effort and time that must be spent before and after performances for set-up and breakdown, along with all the involved hauling of this gear to and from the performance spot and the transporting vehicle. Newer foot-controlled drum machines and off-site produced backing track players, along with effects that sample “loops” for on-the-spot foot-controlled audio production, present more gear to deal with. Using these multiple floor-residing audio effect devices for live performances can present much discomfort with the bending and stooping down often required to get them all set up and packed up on site, especially for older performers. Since a performer utilizing these accompaniment effects now must play in unison with another audio source, he must hear these clearly to do this well, and this may not be easily done through the same speaker sources that the audience hears, especially in noisier crowd environments. So, this means that a small personal audio monitor needs to be involved, which adds even more to the gear menagerie. Taking this idea of other needed and nice-to-have on-stage items further, many performers prefer stage items like a name banner, a cup holder and a place to file already-performed song sheets. There are always extra power cords, signal cords and many other small items that must come, too, typically in an accompanying crate or basket of some kind. The adding of other items like this on top of what was listed earlier altogether can make performance accommodation very arduous, taking much time and effort to place and stow all its pieces, along with the many walking trips back and forth to the vehicle.

### SUMMARY OF THE INVENTION

The present invention is a foldable and mobile all-in-one musical performance “station” for the travelling solo performer that contains a pedalboard for foot-controlled audio effects, an audio monitor, a microphone with adjustable boom, and a music stand. The device can also hold a trough for already-performed song sheets, a cup holder, an optionally displayable act name banner shingle, and a removable miscellaneous cargo basket. It mostly addresses a need of a seated professional solo acoustic guitar player and singer, but could be applied more broadly to a solo performer of any hand-held instrument, generally, especially those that utilize foot-controlled audio backing tracks and effects during performances. The device can be quickly and easily set up, but just as easily collapsed then transported in the fashion of a hand truck, tipping it on its two wheels and rolling it, built with the goal in mind of “one trip to/from the truck”. In its stowed state, it is light enough for a single person to lift into a vehicle, and narrow enough to be rolled through most standard doorways.

No claims of uniqueness are being made for this device's many components individually, but rather the concept of all of them as a group in a single collapsible and transportable unit.

### BRIEF DESCRIPTION OF DRAWING

FIG. 1 is a perspective view of the device in the Stowed State, as it would be for transport.

FIG. 2 is the same perspective view of the device in the Deployed State, as it would be typically used.

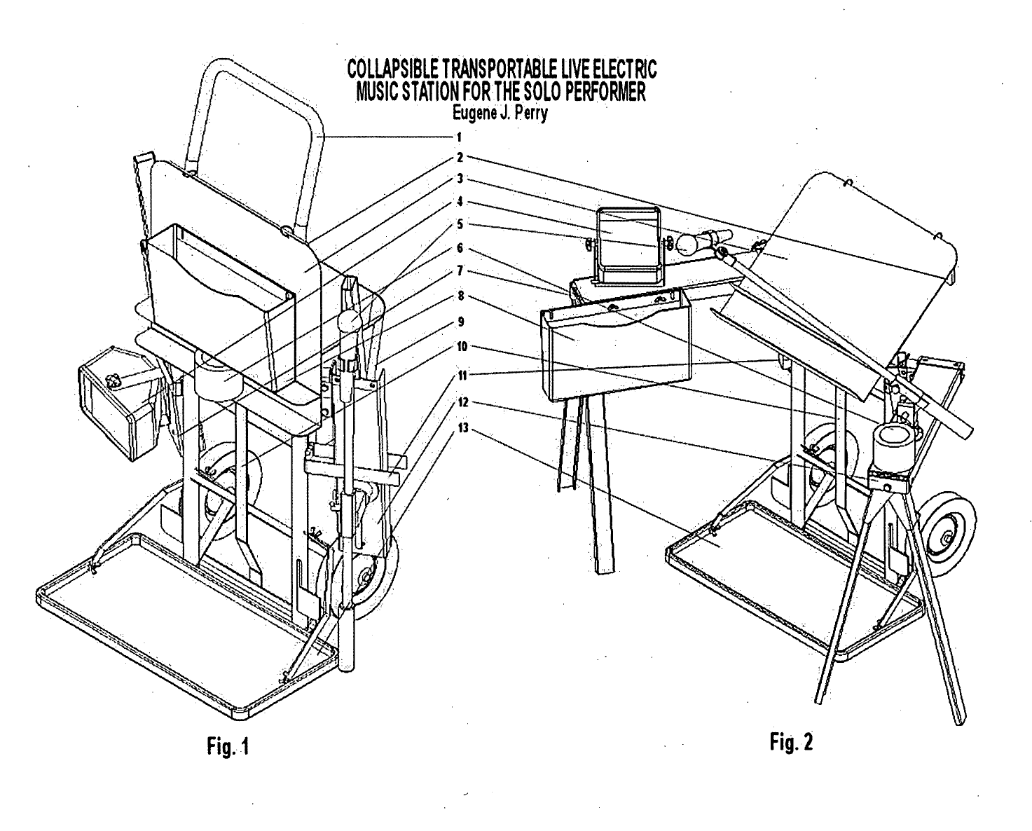

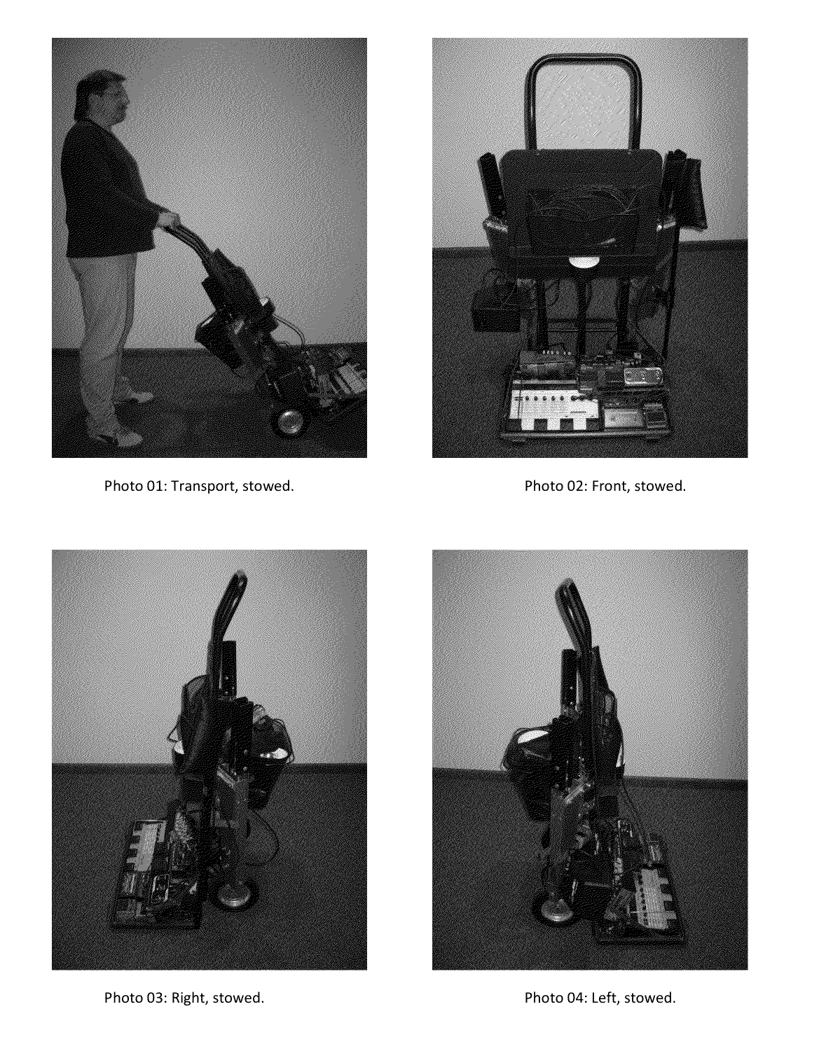

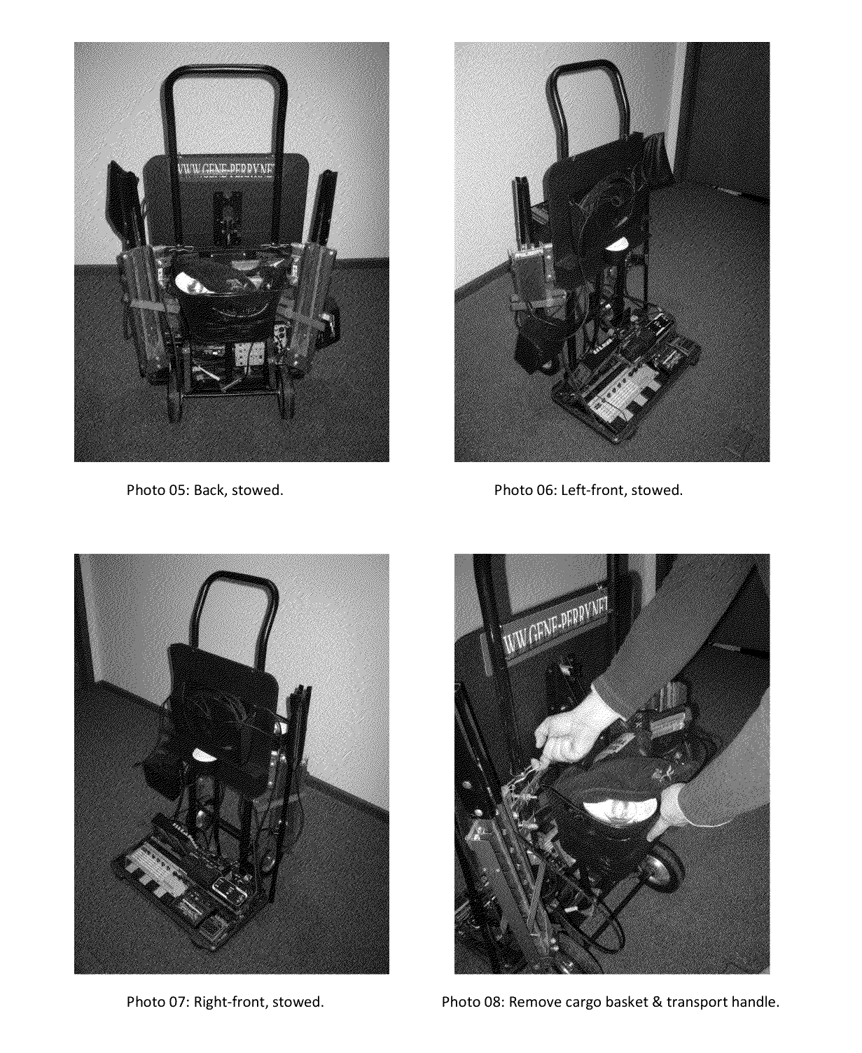

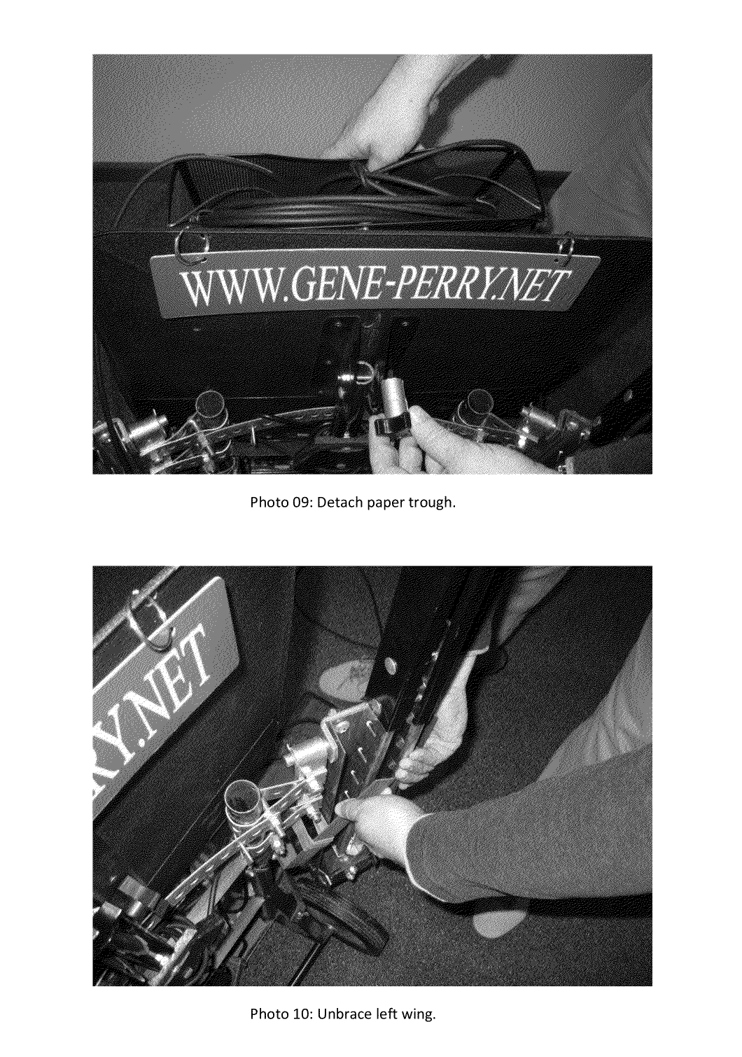

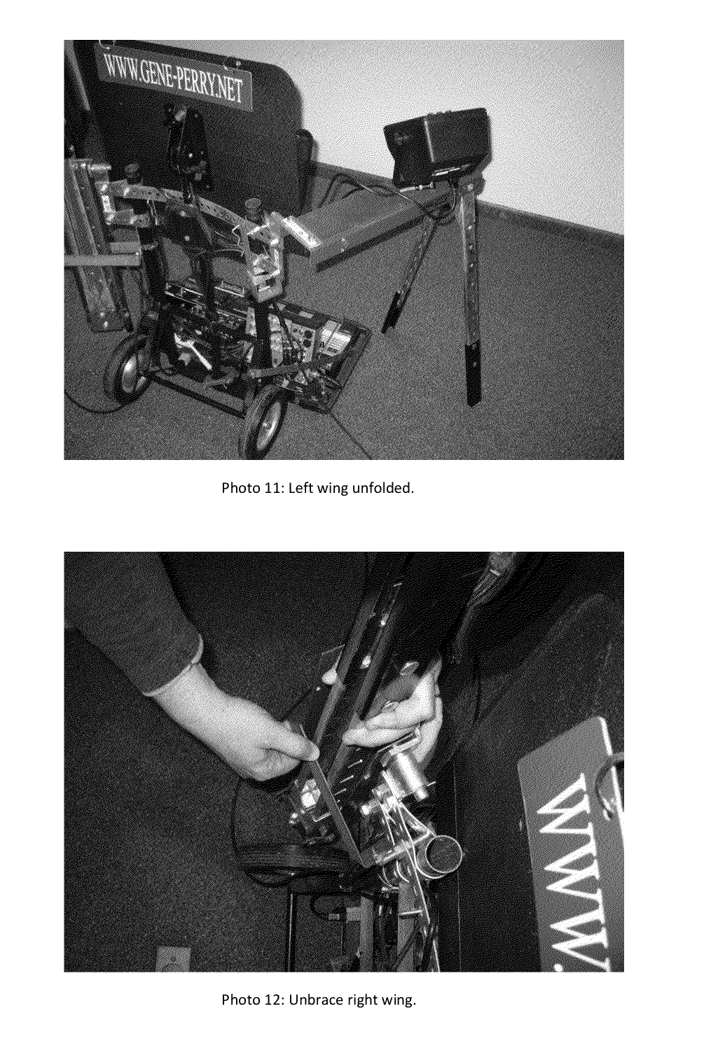

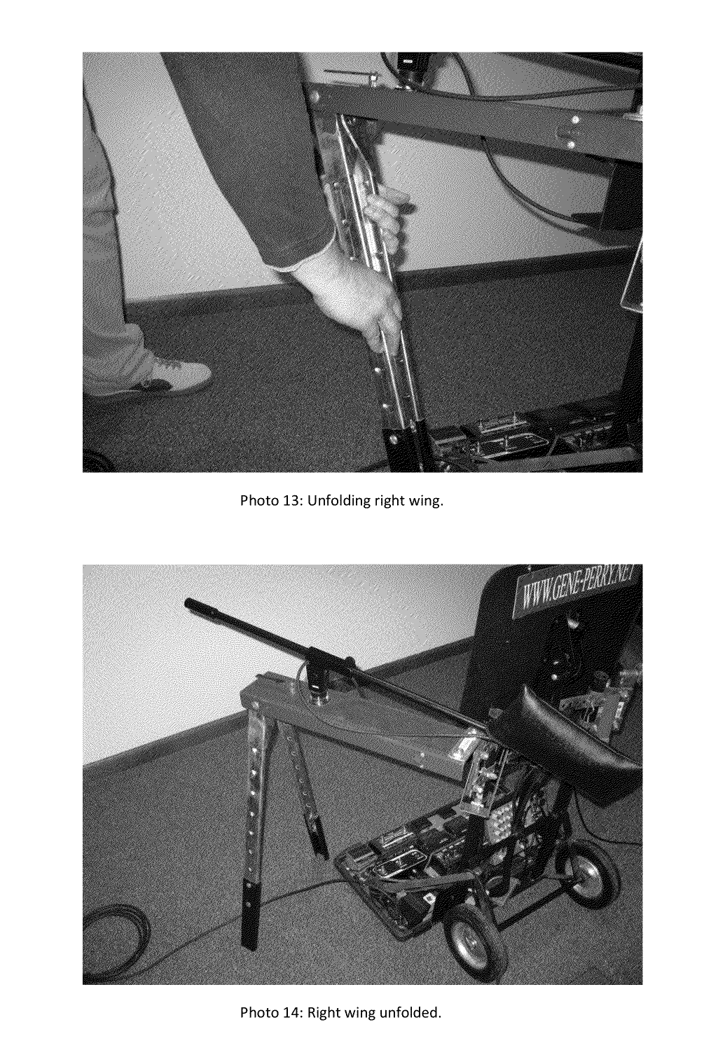

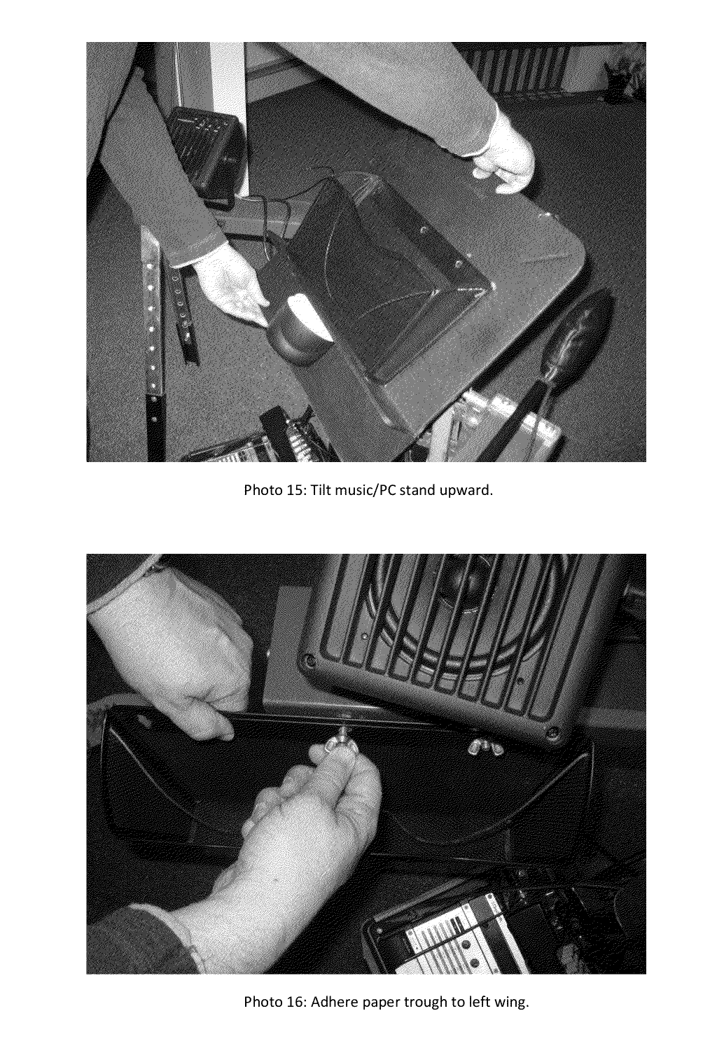

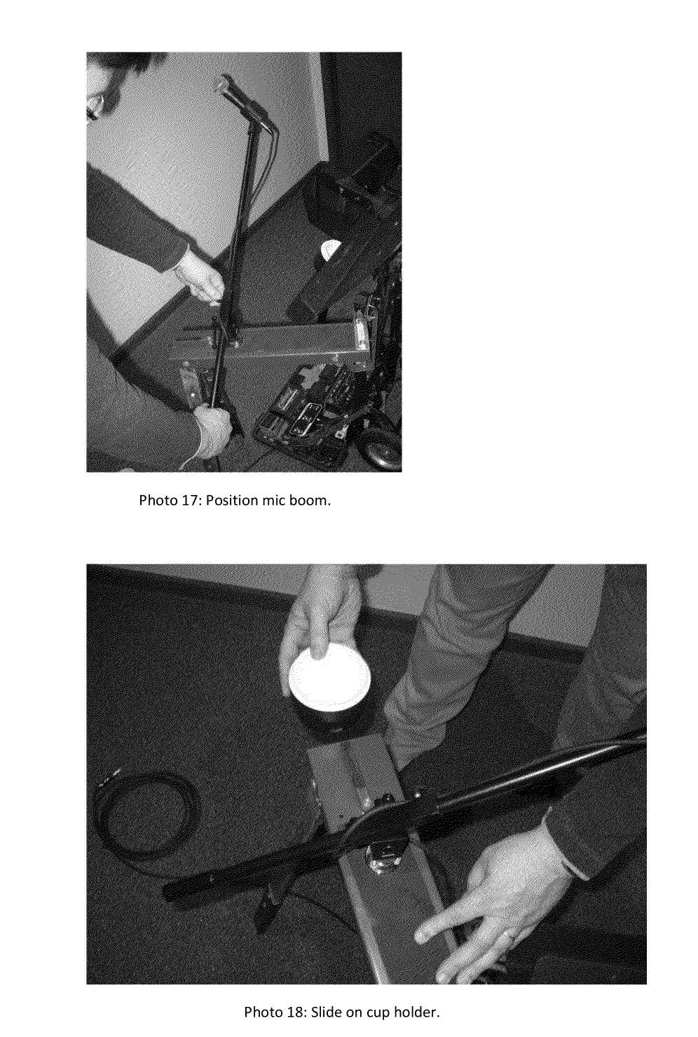

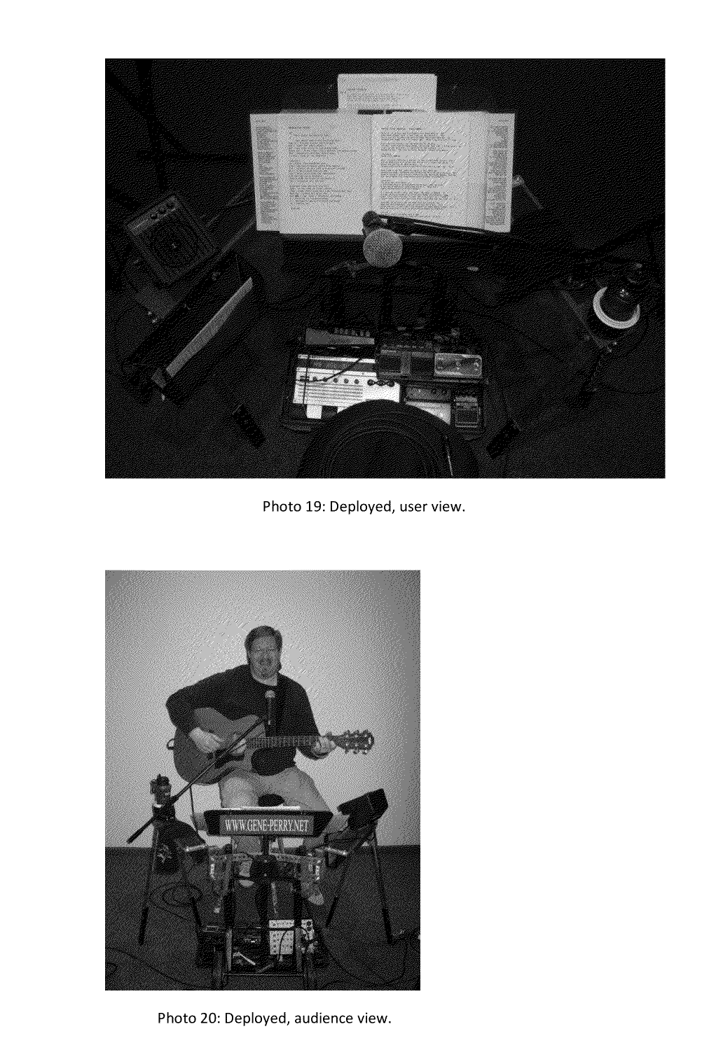

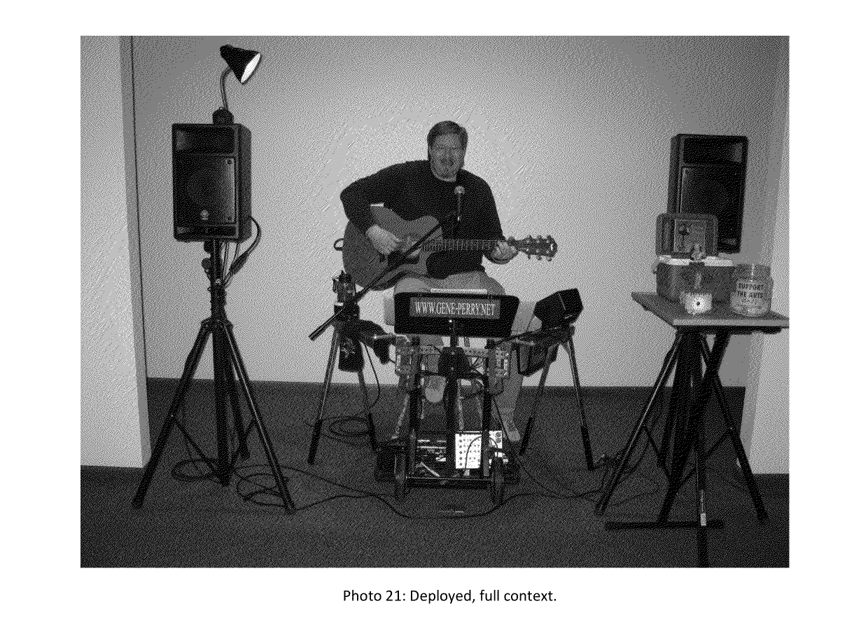

Numbered major items of note are in a list downward between the two drawings, with lines pinpointing the items. These lines most often will identify the items as they are on both drawings, but some items are purposely only on the Stowed State and not the Deployed State, since they are items only utilized in transport, and are shed away when the device is deployed.

Connecting power and signal cables of items that need these things, like the audio monitor, mic and source pedalboard are intentionally not shown in the interest of a more clean and clear illustration. No audio effects pedals are shown contained in the pedalboard either, since combinations of these are variant and suited to the performer's taste. Which kinds of pedals a particular performer chooses here is not important in the understanding of the idea, other than that foot-controlled audio effects can exist, and if they do, they belong here.

### DETAILED DESCRIPTION OF THE INVENTION

Since this invention solves many problems of its context, this section not only is helpful for showing device make-up but can also serve for illustrating its many features in detail. The sub-sections will be each Item, labeled as such, with feature detail being contained within each of these Item descriptions. For features that span multiple Items, an attempt is made to mention other involved Items beyond the containing Item description when appropriate.

Item 1: Transport Handle. This item is only seen in FIG. 1, since it is not a Deployed State item. This U-shaped tubular item is used for transport and can be slid off telescopically from the rest of the Hand Truck Base by removing its left and right cotter pins (not shown behind the Music Sheet/PC Stand). These cotter pins can be put in the same holes they came from when in the Deployed State, so as not to get lost when needed again for breakdown. Removal of this item allows the Music Sheet/PC Stand to pivot upward to the performer, not only for better performer view of the written music, but to lessen the obstructed view of the performer by the audience.

Item 2: Name Banner Shingle. This is an entertainment act nameplate that can hang down from the deployed, angled Music Sheet/PC Stand. It can also be flopped backward if the performer doesn't wish to show this to an audience. (Showing a name during religious worship performances, for example, can be seen as vain and in poor taste.) This serves something of an advertising and sales purpose, not only for audience “following”, but also for the reason that subsequent gig bookings sometimes come from observing audience members, which can make it important for business success that the user's act name is displayed for all to see.

Item 3: Music Sheet/PC Stand. When the Transport Handle is removed, this stand can be pivoted at a desired upward angle to the performer by loosening a knob (not seen, behind the stand), and tightening it when the stand is angled to the degree the performer would like. Most performers prefer paper song sheets (which expands performer song catalog greatly, beyond what can be memorized), but some may prefer a laptop computer device for this purpose, and this stand could also accommodate that. The sturdiness and strong, heavier base of the music stand of this device can tolerate much more load (such as a thick song sheet notebook) than most typical weak and “tippy” music stands, offering a great improvement in this user need. Elastic cords can be strategically placed and hooked on this stand to hold paper sheets down in an outdoor wind. This stand has a second “sill”, where things like guitar capos and extra guitar picks can be placed. This sill also can hold the Cup Holder when in the Stowed State, pinching it securely against the top sill. A similar item that is placed in the stand when in the Stowed State is the Performed Song Sheets Holder, where it can serve the purpose of holding the coiled cords for the two external speakers and the input signal cord for the instrument, all of these coming from the lower Sonic Effects Pedalboard.

Item 4: Audio Monitor. This allows the performer to hear himself and any other present sonic effects and/or backing tracks that are foot-activated. It can pivot both left/right and up/down, but is typically locked down to the ideal orientation for the user upon initial assembly, most times. This kind of monitor is self-amplified and ideally has a volume knob on the front for the user to adjust to varying noise levels of multiple environments. The necessary feeding output signal cord and power cord from the pedalboard are not shown here.

Item 5: Microphone On Boom. This is an anglable, pivotable and slidable shaft that permits the mic assembly to be folded flat and low against the wing when in a Stowed State, and permits desired placement of the mic to the performer's liking in the Deployed State. The boom is able to be locked down in either state with tightening/loosening knobs on each axis. The necessary signal cable going from the mic to the pedalboard in the illustration is not shown. For left-handed guitar players, see note in Item 7.

Item 6: Cup Holder. A seemingly “luxurious” item, but for singers singing for gigs that last many hours, it is an important tool in keeping a performer's vocal chords regularly moist for optimal singing performance. This item slides onto a cantilevered piece of rod iron running parallel to the wing beam when in the Deployed State, and is placed between the Music Sheet/PC Stand's sills when in the Stowed State.

Item 7: Left Foldable Wing. A “wing” is an elaborate beam which can hold various items of the device, being vertical when in a Stowed State and horizontal and unfolded when in a Deployed State. It holds three hinges to do this: The first top one brings the bottom end of the beam upward toward the performer making it horizontal, the second bottom one allows the two legs to hinge out of the beam assembly, and the third allows the legs to spread out and set on the floor to hold the beam securely in place. The first main hinge is made up of a round peg sticking out of the beam that slips into a round hole on the Hand Truck Base, with just a cotter pin going through a small hole in the peg to hold the wing in place. With the removal of this small pin, a wing can be easily removed and re-adhered later to have the whole device temporarily fit through an unusually narrow doorway. The wings sit at coarsely a horizontal 135-degree-angle to the Hand Truck Base when deployed, making the two wings and the middle base form something like three connected sides of a perfect octagon, when viewed downward from overhead. The drawing shows the Audio Monitor adhered on this foldable wing on the performer's left. Most guitarists are right-handed, so this is the side where the guitar's neck would be sticking out, him wearing the instrument and seated at the device, and the guitar's body being under the right arm of the player. It serves a right-handed guitarist best to keep this monitor away from the guitar body in the interest of reducing audio feedback, and, it is also best to keep the cantilevering guitar neck from accidentally interfering and hitting the Microphone On Boom placed in the air, so this boom must necessarily reside on the wing of the performer's right side. It is possible, though, that a left-handed guitarist may prefer this monitor to be on his right, and the Microphone On Boom be on this left wing, instead, and this switch of items between the wings could certainly be accommodated on initial user assembly.

Item 8: Performed Song Sheets Holder. In the Deployed State, this is a nearby place where the performer can file paper song sheets already performed, so as not to mix these songs with those not performed yet. It is basically a mesh-wired wall paper trough which hooks onto a wing, the kind sometimes seen on or near work office doors. This also serves well in keeping papers like this from blowing away in an outdoor wind, too. When in the Stowed State, this trough is latched onto the Music Sheet/PC Stand and can be used to hold the coiled cords for the two external speakers and the input signal cord for the instrument, all of these coming from the lower Sonic Effects Pedalboard.

Item 9: Cargo Basket. This item is only used in the Stowed State, and can hold any various small extra gear elements that could be needed. It basically works much like a bicycle handlebar detachable basket. It latches to a trapezoid-shaped plate on the Hand Truck Base, is held in place with gravity and can be lifted off this plate for deployment. Things this basket could hold would be a wedge to hold open spring-loaded doors, a tip jar, extra backup power and signal cables, a goosenecked office lamp with a clamp for stage lighting, CD's for sale, duct tape, tools and other small items.

Item 10: Hand Truck Base. The structural central element of the device to which all other items adhere to, directly or indirectly, permanently or temporarily. It is solid, strong, light and has two non-pneumatic tires for tipping the whole unit and rolling in a Stowed State, being pushed or pulled using the removable Transport Handle.

Item 11: Hinged U-Brace Wing Holders. These braces serve the dual purpose of keeping the wing both together and to keep it from “swinging” on the wings' upper hinges during tipping and transport. The braces are brought down to keep the wings securely in place when in a Stowed State, and brought up to allow the unfolding of the wing.

Item 12: Right Foldable Wing. Much of what can be said about this item can be read in the description of Item 7, the Left Foldable Wing, this basically being a mirror-image of that item.

Item 13: Sonic Effects Pedalboard. The electrical central element of the device that holds all audio effects foot pedals, a mixer, a power strip, and is the source or destination of all involved signal and power cords. This whole pedalboard is braced in such a way that it is solidly adhered, yet can be easily removed with no accompanying tool, such as with butterfly nuts, for instance. Nothing is shown as being in this item on the drawing, since what is exactly placed here and in what order in the signal “chain” has much to do with the opinions and tastes of the performer. However, it is recommended that an overall sound mixer and an overall power strip be housed here, in the interest of perpetuating the all-in-one concept that the device is trying to achieve. Cords that connect to the mic and the monitor of the device itself can always be self-contained and always connected, never needing any special set-up effort, then. Beyond this, if the prior mentioned recommendation is followed, the whole device can have only four simple external electrical connections in total: An overall power cord to plug into an AC outlet, an instrument input signal cord, and two signal cords feeding a powered speaker each on the left and right of the performer. Use of an already-provided “house” PA would only use one of these output signal cables. Most of these cords can coil and be placed in the Performed Song Sheets Holder which is latched onto the Music Sheet/PC Stand in the Stowed State, containing it all cleanly for easy transport. Everything this item contains must be decently adhered for accommodating tipping and transport, recommended methods being strong but temporary ones like elastic hook cords, Velcro strips and other various plastic and wire ties.

1. An all-in-one collapsible, transportable live music station for the solo musician performer, containing various needed devices on a central two-wheeled hand truck, being narrow enough in its stowed state to be tipped and wheeled through most standard doorways, light enough to be singularly manually lifted into and out of vehicles, and can be deployed out for a seated solo musician (most likely a singing guitar player using supplemental audio effects and backing tracks) to comfortably utilize all its features during performances, while also saving much time and effort in gear transport, set-up and breakdown, said on-board devices necessarily including:
an audio effects pedalboard with foot-controlled music accompaniment effects with all related electronic connectors,
a personal audio monitor,
a microphone on a boom, and
a music stand,
and optionally including betterment devices such as:
a side cup holder,
a side sheet music trough,
an optionally displayable front-facing act name banner shingle, and
a removable miscellaneous cargo basket.
